(19) United States
(12) Patent Application Publication
(10) Pub. No.: US 2022/0229775 A1
(43) Pub. Date: Jul. 21, 2022

(54) DATA STORAGE DEVICE AND OPERATING METHOD THEREOF

(71) Applicant: SK hynix Inc., Gyeonggi-do (KR)

(72) Inventor: Jin Pyo KIM, Gyeonggi-do (KR)

(21) Appl. No.: 17/378,147

(22) Filed: Jul. 16, 2021

(30) Foreign Application Priority Data
Jan. 15, 2021 (KR) 10-2021-0005807

(51) Int. Cl. G06F 12/02; G06F 12/0882; G06F 12/0891

(52) U.S. Cl. CPC G06F 12/0253; G06F 12/0246; G06F 2212/7211; G06F 12/0891; G06F 12/0882

(57) ABSTRACT

A data storage device includes: a nonvolatile memory apparatus including a plurality of memory blocks allocated as first open blocks for purposes other than garbage collection and a controller. The controller is configured to allocate, among the first open blocks, an open block for garbage collection for performing a garbage collection operation when switching the nonvolatile memory apparatus to a garbage collection mode, and to copy data stored in valid pages of a victim block, to store the copied data into the open block for garbage collection, and to erase the victim block during the garbage collection operation, thereby securing a free block.

### CROSS-REFERENCES TO RELATED APPLICATION

The present application claims priority under 35 U.S.C. § 119(a) to Korean application number 10-2021-0005807, filed on Jan. 15, 2021, which is incorporated herein by reference in its entirety.

### BACKGROUND

### 1. Technical Field

Various embodiments of the present disclosure generally relate to a semiconductor apparatus, and more particularly, to a data storage device and an operating method thereof.

### 2. Related Art

A data storage device using a memory apparatus is advantageous in that stability and durability are excellent due to the absence of a mechanical driving unit, an information access speed is very fast, and power consumption is small. Examples of the data storage device having such advantages may include a universal serial bus (USB) memory apparatus, a memory card having various interfaces, a universal flash storage (UFS) device, and a solid-state drive.

A garbage collection is an operation for securing a free block. It may be difficult to secure a free block when the data storage device does not have enough time for a garbage collection operation or due to repetitions of power-off, recovery, flush processes, and the like.

### SUMMARY

Various embodiments of the present disclosure are directed to providing a data storage device with improved free block securing performance and an operating method thereof.

In an embodiment of the present disclosure, a data storage device may include: a nonvolatile memory apparatus including a plurality of memory blocks allocated as first open blocks for purposes other than garbage collection; and a controller configured to allocate, among the first open blocks, an open block for garbage collection for performing a garbage collection operation when switching the nonvolatile memory apparatus to a garbage collection mode, and to copy data stored in valid pages of a victim block, to store the copied data into the open block for garbage collection, and to erase the victim block during the garbage collection operation, thereby securing a free block.

In an embodiment of the present disclosure, a data processing system may include: a host configured to generate a garbage collection request for performing only a garbage collection operation according to a preset condition; and a data storage device configured to allocate an open block for garbage collection for performing the garbage collection operation among first open blocks for purposes other than garbage collection when switching to a garbage collection mode as a garbage collection request is received, and to perform the garbage collection operation.

In an embodiment of the present disclosure, a data storage device may include: a nonvolatile memory apparatus including open blocks; and a controller configured to control the nonvolatile memory apparatus to perform, with the open blocks, any of a garbage collection operation, a wear leveling operation, a read reclaim operation and a host write operation. The nonvolatile memory apparatus performs the garbage collection operation while not performing any of the wear leveling operation, the read reclaim operation and the host write operation.

In accordance with the present embodiments, since free blocks are stably secured, it can be expected that an operation processing time for a data write instruction from the host can be shortened.

Furthermore, in accordance with the present embodiments, since open blocks for purposes other than garbage collection are used instead of free blocks during the garbage collection operation, free blocks can be prevented from being unnecessarily consumed, thereby stably maintaining a state of securing free blocks.

### BRIEF DESCRIPTION OF THE DRAWINGS

FIG. 1 is a diagram illustrating a configuration of a data storage device in accordance with an embodiment of the present disclosure.

FIG. 2 and FIG. 3 are diagrams for describing a method of securing a free block in accordance with an embodiment of the present disclosure.

FIG. 4 and FIG. 5 are diagrams for describing a method of selecting a victim block in accordance with an embodiment of the present disclosure.

FIG. 6 is a diagram for describing another method of securing a free block in accordance with an embodiment of the present disclosure.

FIG. 7 is a diagram for describing a method of performing garbage collection in accordance with an embodiment of the present disclosure.

FIG. 8 is a diagram illustrating a configuration of a data processing system in accordance with an embodiment of the present disclosure.

FIG. 9 is a diagram illustrating a data processing system including a solid state drive (SSD) in accordance with an embodiment of the present disclosure.

FIG. 10 is a diagram illustrating a configuration of a controller of FIG. 9 in accordance with an embodiment of the present disclosure.

FIG. 11 is a diagram illustrating a data processing system including a data storage device in accordance with an embodiment of the present disclosure.

FIG. 12 is an exemplary diagram illustrating a data processing system including a data storage device in accordance with an embodiment of the present disclosure.

FIG. 13 is a diagram illustrating a network system including a data storage device in accordance with an embodiment of the present disclosure.

FIG. 14 is a diagram illustrating a nonvolatile memory apparatus included in a data storage device in accordance with an embodiment of the present disclosure.

### DETAILED DESCRIPTION

Hereinafter, various embodiments will be described with reference to the accompanying drawings.

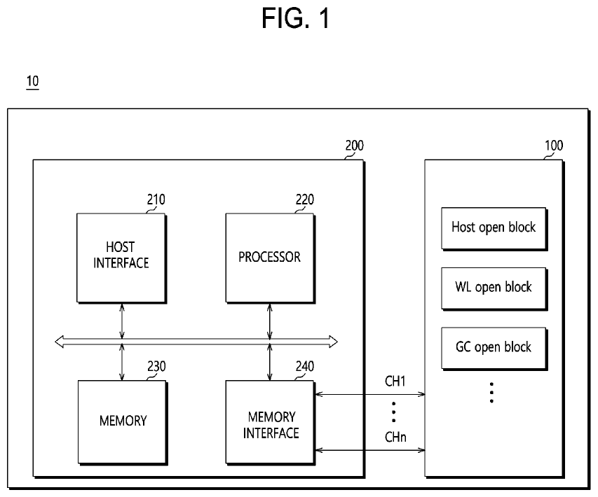

FIG. 1 is a diagram illustrating a configuration of a data storage device 10 in accordance with an embodiment of the present disclosure.

Referring to FIG. 1, the data storage device 10 in accordance with the present embodiment may store data that is accessed by a host (not illustrated) such as a cellular phone, an MP3 player, a laptop computer, a desktop computer, a game machine, a television, and an in-vehicle infotainment system. The data storage device 10 may also be called a memory system.

The data storage device 10 may be fabricated as any of various types of storage devices according to an interface protocol connected to the host. For example, the data storage device 10 may be configured as any of various types of storage devices such as a multimedia card in the form of a solid state drive (SSD), an MMC, an eMMC, an RS-MMC, or a micro-MMC, a secure digital card in the form of an SD, a mini-SD, or a micro-SD, a universal serial bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-E) card, a compact flash (CF) card, a smart media card, and a memory stick.

The data storage device 10 may be fabricated as any of various types of packages. For example, the data storage device 10 may be fabricated as any of various types of packages such as a package on package (POP), a system in package (SIP), a system on chip (SOC), a multi-chip package (MCP), a chip on board (COB), a wafer-level fabricated package (WFP), and a wafer-level stack package (WSP).

The data storage device 10 may include a nonvolatile memory apparatus 100 and a controller 200.

Referring to FIG. 1, the nonvolatile memory apparatus 100 may include a plurality of memory blocks allocated as first open blocks for purposes other than garbage collection.

Furthermore, the nonvolatile memory apparatus 100 may also include an open block GC open block for garbage collection in addition to the first open block. In such a case, the open block GC open block for garbage collection may refer to a memory block into which data in a valid page of a victim block is copied.

The first open block may include an open block for internal operations including wear leveling and read reclaim operations and an open block Host open block for host write.

The open block Host open block for host write may be an open block for a host writing operation of writing data transferred from the host (not illustrated). The open block for internal operations may also be an open block WL open block for wear leveling, or an open block for read reclaim. The open block WL open block for wear leveling may be used for a wear leveling operation. The open block for read reclaim may be used for a read reclaim operation.

The aforementioned first open block refers to an open block allocated for purposes other than garbage collection and may include an open block for purposes other than garbage collection, in addition to the aforementioned wear leveling, read reclaim, and host write.

The use of each open block may be set to a purpose used at the time when data is first stored in the nonvolatile memory apparatus 100 under the control of the controller 200 but is not limited thereto. Classifying the use of the open blocks may be for extending the life of a memory by distinguishing and managing the open blocks according to the attributes of data to be stored.

The aforementioned block refers to a plurality of data page units in which erase operations are simultaneously performed, and a plurality of block units managed as one are referred to as a super block. Accordingly, a data storage area in the nonvolatile memory apparatus 100 may refer to a die, a plain, a super block, a block, a data page and the like. The block disclosed in the present embodiment may be a single block or a super block.

The nonvolatile memory apparatus 100 may operate as a storage medium of the data storage device 10. The nonvolatile memory apparatus 100 may be configured as any of various types of nonvolatile memory apparatuses, such as a NAND flash memory apparatus, a NOR flash memory apparatus, a ferroelectric random access memory (FRAM) using a ferroelectric capacitor, a magnetic random access memory (MRAM) using a tunneling magneto-resistive (TMR) film, a phase change random access memory (PRAM) using chalcogenide alloys, and a resistive random access memory (ReRAM) using a transition metal oxide.

The nonvolatile memory apparatus 100 may include a memory cell array (not illustrated) having a plurality of memory cells arranged in respective intersection regions of a plurality of bit lines (not illustrated) and a plurality of word lines (not illustrated). For example, each memory cell of the memory cell array may be a single level cell (SLC) that stores one bit, a multi-level cell (MLC) capable of storing two bits of data, a triple level cell (TLC) capable of storing three bits of data, or a quadruple level cell (QLC) capable of storing four bits of data. The memory cell array may include at least one of the single level cell, the multi-level cell, the triple level cell, and the quadruple level cell. For example, the memory cell array may include memory cells having a two-dimensional horizontal structure or memory cells having a three-dimensional vertical structure.

The controller 200 may control all operations of the data storage device 10 by driving firmware or software loaded on a memory 230. The controller 200 may decode and drive a code type instruction or an algorithm such as firmware or software. The controller 200 may be implemented as hardware or a combination of hardware and software.

When switching the nonvolatile memory apparatus 100 to a garbage collection mode, the controller 200 may allocate an open block GC open block for garbage collection for performing a garbage collection operation among the first open blocks, and copy data stored in valid pages of a victim block, store the copied data into the open block GC open block for garbage collection, and erase the victim block during the garbage collection operation, thereby securing a free block.

The aforementioned garbage collection operation may be performed by copying valid pages from a block including the valid pages and invalid pages into the open block GC open block for garbage collection and deleting or erasing the block including the invalid pages. The deleted block or erased block may be referred to as a free block.

Specifically, the controller 200 may include a host interface 210, a processor 220, the memory 230, and a memory interface 240. Although not illustrated in FIG. 1, the controller 200 may further include an error correction code (ECC) engine that generates a parity by ECC-encoding write data provided from the host and ECC-decodes read data read from the nonvolatile memory apparatus 100 by using the parity. The ECC engine may be provided inside or outside the memory interface 240.

The host interface 210 may serve as an interface between the host and the data storage device 10 corresponding to the protocol of the host. For example, the host interface 210 may communicate with the host through any of protocols such as a universal serial bus (USB), a universal flash storage (UFS), a multimedia card (MMC), a parallel advanced technology attachment (PATA), a serial advanced technology attachment (SATA), a small computer system interface (SCSI), a serial attached SCSI (SAS), a peripheral component interconnection (PCI), and a PCI express (PCI-E).

In the present embodiment, when switching the nonvolatile memory apparatus 100 to the garbage collection mode, the processor 220 may not use an open block for garbage collection from among free blocks, and use an open block, which is being used for purposes other than garbage collection (for example, host write, wear leveling, read reclaim, and the like), as the open block for garbage collection.

Specifically, when switching the nonvolatile memory apparatus 100 to the garbage collection mode, the processor 220 may allocate the open block GC open block for garbage collection for performing the garbage collection operation among the first open blocks. In such a case, the first open block may refer to an open block for purposes other than garbage collection.

The garbage collection mode disclosed in the present embodiment may refer to a mode in which the host write and internal operations are stopped and only the garbage collection operation is performed.

In accordance with the present embodiment, even when the garbage collection operation is performed in order to secure free blocks, free block consumption may be reduced by allocating, as the open block GC open block for garbage collection, an open block for purposes other than garbage collection other than a free block.

When the total number of free blocks in the nonvolatile memory apparatus 100 is equal to or less than a reference number or when a garbage collection request transferred from the host (not illustrated) is received, the processor 220 may switch the nonvolatile memory apparatus 100 to the garbage collection mode in which only the garbage collection operation is performed.

During the garbage collection operation, the processor 220 may copy data stored in the valid pages of the victim block, store the copied data into the open block GC open block for garbage collection, and erase the victim block, thereby securing a free block.

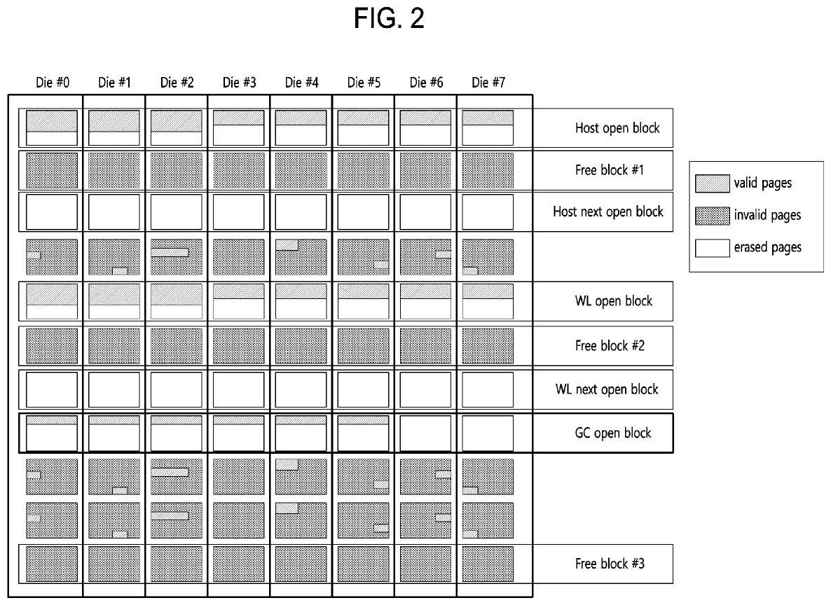

FIG. 2 and FIG. 3 are diagrams for describing a method of securing a free block in accordance with an embodiment of the present disclosure. FIG. 2 illustrates an example in which the garbage collection operation is performed, and FIG. 3 illustrates an example in which the open block GC open block for garbage collection is selected from the first open blocks.

As illustrated in FIG. 2, in a state in which an open block Host open block for host write, an open block WL open block for wear leveling, an open block GC open block for garbage collection, and free blocks Free block #1 to Free block #3have been allocated in the nonvolatile memory apparatus 100, the processor 220 may perform the garbage collection operation. In such a case, Free block #1 to Free block #3 of FIG. 2 are illustrated as a state in which invalid pages exist before erasing; however, the present disclosure is not limited thereto and other states (e.g., an erase state) is also possible.

As illustrated in FIG. 3, when the storage space of a previous open block Prey GC open block for garbage collection is not sufficient and a next open block for garbage collection needs to be allocated, or when an open block for garbage collection needs to be allocated first, the processor 220 may allocate an open block for purposes other than garbage collection (for example, an open block WL open block for wear leveling) as an open block GC open block for garbage collection. In such a case, the selected open block WL open block for wear leveling may be an open block WL open block for wear leveling on which a wear leveling operation has been previously performed, that is, an open block in which data has been written.

The processor 220 may repeatedly perform the garbage collection operation until the total number of free blocks is equal to the reference number. For example, when the total number of free blocks is 3 and the reference number is 6, the processor 220 may perform the garbage collection operation until three free blocks are further secured.

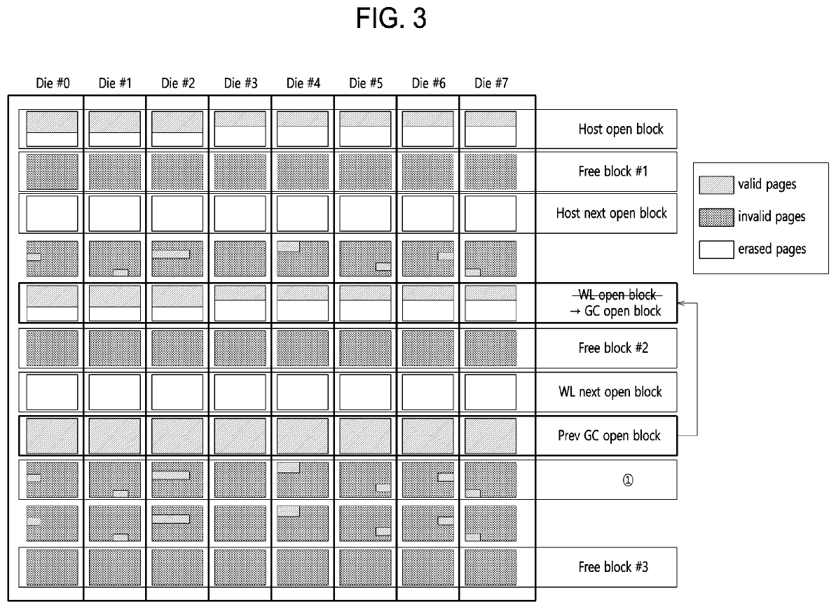

FIG. 4 and FIG. 5 are diagrams for describing a method of selecting a victim block in accordance with an embodiment of the present disclosure. FIG. 4 illustrates an example in which a victim block candidate includes a signal block including only one block, and FIG. 5 illustrates an example in which a victim block candidate is a super block.

When selecting victim blocks during the garbage collection operation, the processor 220 may select victim blocks a number of which corresponds to a difference between the reference number and the total number of free blocks, in an ascending order of the number of valid pages among a plurality of victim block candidates.

Referring to FIG. 4, when the reference number is 6 and the total number of free blocks is 4, the processor 220 needs to additionally secure two free blocks, and may select Free block #0 and Free block #2 as victim blocks in an ascending order of the number of valid pages among victim block candidates Free block #0 to Free block #2. In other words, Free block #1 may have a greater number of valid pages than Free block #2, and Free block #2 may have a greater number of valid pages than Free block #0.

Referring to FIG. 5, when the reference number is 6 and the total number of free blocks is 4, the processor 220 needs to additionally secure two free blocks, and may select Super block #0 and Super block #2 as victim blocks in an ascending order of the number of valid pages among victim block candidates Super block #0 to Super block #2. In other words, Super block #1 may have a greater number of valid pages than Super block #2, and Super block #2 may have a greater number of valid pages than Super block #0.

In such a case, when the victim block candidate is one super block or a plurality of super blocks, the victim block may be selected based on the number of all valid pages of a super block grouped into the same group.

During the garbage collection operation, the processor 220 may check a free space of the open block GC open block for garbage collection and the number of valid pages of the victim block and determine whether the checked free space can store all data stored in the valid pages of the victim block.

If the victim block includes at least one super block, the processor 220 may compare the number of all valid pages of the at least one super block with the free space of the open block GC open block for garbage collection.

For example, referring to FIG. 3, when a super block \textcircled{1} is a victim block, the processor 220 may compare the number of valid pages of the super block \textcircled{1} with the free space of the open block GC open block for garbage collection. That is, the processor 220 checks whether all data in the valid pages of the super block \textcircled{1} can be copied into the open block GC open block for garbage collection.

When it is not possible to store all the data, which are stored in the valid pages of the victim block, in the free space of the open block GC open block for garbage collection, if the free space of the open block GC open block for garbage collection is being reduced less than a preset reference value while the valid pages of the victim block are being copied to the open block GC open block, the processor 220 may allocate a next open block for garbage collection among the first open blocks. In such a case, allocating the next open block for garbage collection is for enabling the garbage collection operation to be continuously performed.

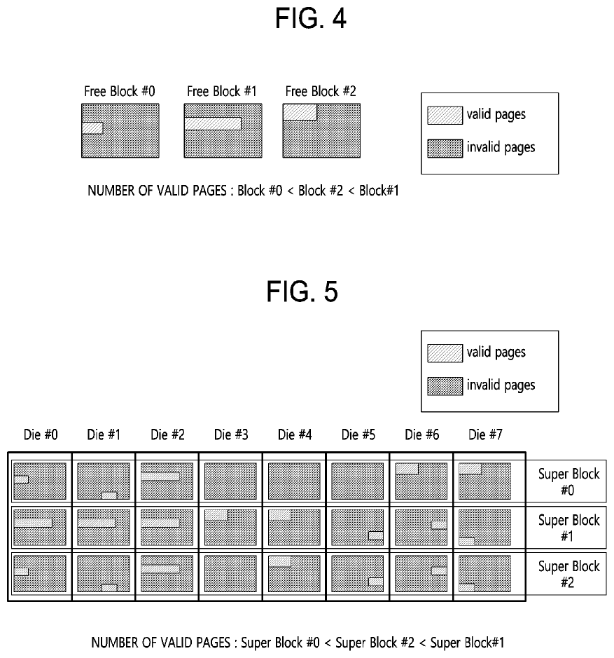

FIG. 6 is a diagram for describing a method of securing a free block in accordance with an embodiment of the present disclosure.

When switching the nonvolatile memory apparatus 100 to the garbage collection mode, the processor 220 may increase the total number of free blocks by adding free blocks reserved for the host write and internal operations to a free block list.

In such a case, the free blocks reserved for the host write and internal operations may refer to blocks in which data has not been written after being erased. That is, the free blocks reserved for the host write and internal operations refer to blocks allocated for the host write and internal operations, but not yet used for the host write and internal operations.

For example, referring to FIG. 6, when there are three free blocks Free block #1 to Free block #3, the processor 220 may allocate a next open block Host next open block for host write and a next open block WL next open block for wear leveling, which are open blocks in a state of being free blocks allocated for purposes other than garbage collection, as Free block #4 and Free block #5, respectively, before switching the nonvolatile memory apparatus 100 to the garbage collection mode.

The processor 220 may allocate, as free blocks, the open blocks in the state of being free blocks allocated for purposes other than garbage collection, and then add the free blocks to the free block list.

Referring to FIG. 6, in the state in which there are three free blocks Free block #1 to Free block #3, the number of free blocks increases to 5 by additionally securing Free block #4 and Free block #5.

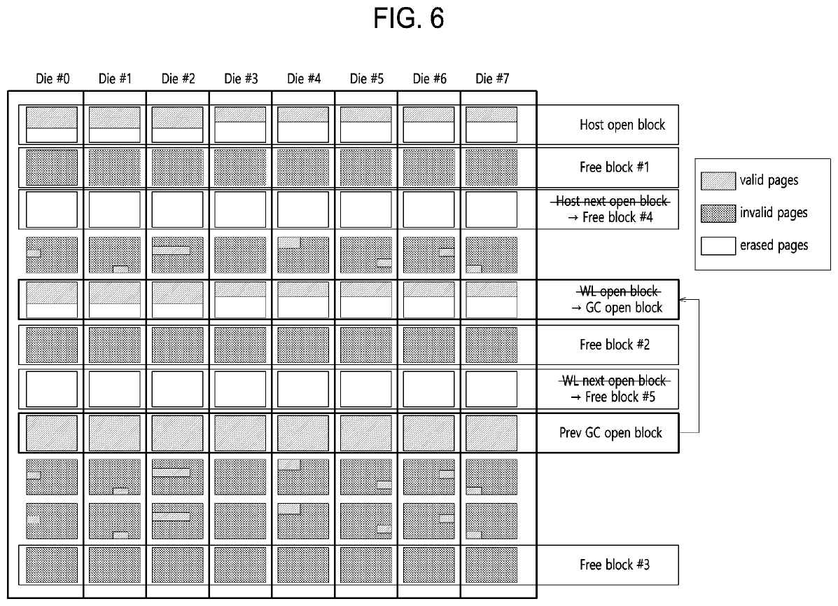

FIG. 7 is a diagram for describing a method of performing garbage collection in accordance with an embodiment of the present disclosure.

During the garbage collection operation, the processor 220 may determine a final write position of the open block GC open block for garbage collection by referring to a mapping table and then store the data, which are stored in the valid pages of the victim block, into a position following the determined final write position.

In such a case, the mapping table may include data write information in which logical addresses and physical addresses for each data block are matched.

As illustrated in FIG. 7, the processor 220 may determine a final write position of a block allocated as the open block GC open block for garbage collection in the open block for purposes other than garbage collection (for example, the open block WL open block for wear leveling), and then store valid data into a position following the final write position.

The first open block, the victim block, the free block, and the open block GC open block for garbage collection disclosed with reference to FIG. 1 to FIG. 7 may each be a super block including at least two blocks or a single block including one block.

Referring back to FIG. 1, the processor 220 may be composed of a micro control unit (MCU) and a central processing unit (CPU). The processor 220 may process requests transmitted from the host. In order to process the requests transmitted from the host, the processor 220 may drive the code type instruction or algorithm loaded on the memory 230, that is, the firmware, and control operations of internal devices, such as the host interface 210, the memory 230, and the memory interface 240, and the nonvolatile memory apparatus 100.

The processor 220 may generate control signals for controlling the operation of the nonvolatile memory apparatus 100 on the basis of the requests transmitted from the host, and provide the generated control signals to the nonvolatile memory apparatus 100 through the memory interface 240.

The memory 230 may be composed of a random access memory such as a dynamic random access memory (DRAM) and a static random access memory (SRAM). The memory 230 may store the firmware that is driven by the processor 220. Furthermore, the memory 230 may store data required for driving the firmware, for example, meta data. That is, the memory 230 may operate as a working memory of the processor 220. Although not illustrated in FIG. 1, the processor 220 may further include a processor-dedicated memory disposed adjacent to the processor 220, and the firmware and the meta data stored in the memory 230 may also be loaded on the processor-dedicated memory.

The meta data may refer to data, which is generated and used by the controller 200 that directly controls the nonvolatile memory apparatus 100, such as firmware codes, address mapping data, and data for managing user data. Since the meta data is generated by the controller 200, it may be provided from the controller 200.

The user data may refer to data, which is generated and used by a software layer of the host controlled by a user, such as application program codes and files. The user data is generated by the software layer of the host, but may be provided from the controller 200 at the request of the host.

The memory 230 may be configured to include a data buffer for temporarily storing write data to be transmitted from the host to the nonvolatile memory apparatus 100, or read data to be read from the nonvolatile memory apparatus 100 and to be transmitted to the host. That is, the memory 230 may operate as a buffer memory.

FIG. 1 illustrates an example in which the memory 230 is provided inside the controller 200; however, the memory 230 may also be provided outside the controller 200.

The memory interface 240 may control the nonvolatile memory apparatus 100 under the control of the processor 220. When the nonvolatile memory apparatus 100 is configured as a NAND flash memory, the memory interface 240 may also be referred to as a flash control top (FCT). The memory interface 240 may transmit the control signals generated by the processor 220 to the nonvolatile memory apparatus 100. The control signals may include a command, an address, an operation control signal and the like for controlling the operation of the nonvolatile memory apparatus 100. The operation control signal may include, for example, a chip enable signal, a command latch enable signal, an address latch enable signal, a write enable signal, a read enable signal, a data strobe signal, and the like, but is not particularly limited thereto. Furthermore, the memory interface 240 may transmit write data to the nonvolatile memory apparatus 100, or receive read data from the nonvolatile memory apparatus 100.

The memory interface 240 and the nonvolatile memory apparatus 100 may be electrically connected through a plurality of channels CH1 to CHn. The memory interface 240 may transmit signals such as the command, the address, the operation control signal, and data (that is, the write data) to the nonvolatile memory apparatus 100 through the plurality of channels CH1 to CHn. Furthermore, the memory interface 240 may receive a status signal (for example, ready/busy) and data (that is, the read data) from the nonvolatile memory apparatus 100 through the plurality of channels CH1 to CHn.

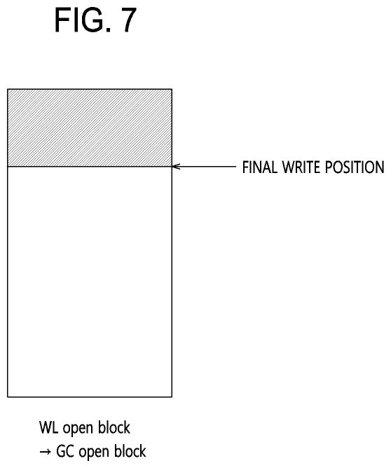

FIG. 8 is a diagram illustrating a configuration of a data processing system 20 in accordance with an embodiment of the present disclosure.

Referring to FIG. 8, the data processing system 20 may include a host 300 and the data storage device 10.

The host 300 may generate a garbage collection request for performing only the garbage collection operation according to a preset condition.

As an example, before any of power-off, sleep mode switching, and idle mode switching of the nonvolatile memory apparatus 100 is performed, the host 300 may generate the garbage collection request and transmit the garbage collection request to the data storage device 10.

As another example, when the total number of free blocks in the nonvolatile memory apparatus 100 is equal to or less than the reference number, the host 300 may generate the garbage collection request and transmit the garbage collection request to the data storage device 10.

To this end, the host 300 needs to recognize the number of free blocks by periodically or aperiodically transmitting a query to the data storage device 10.

In a case where the host 300 transmits the garbage collection request to the data storage device 10 before any of the power-off, the sleep mode switching, and the idle mode switching of the nonvolatile memory apparatus 100 is performed, when a garbage collection completion response transferred from the data storage device 10 is received, the host 300 may perform any of the power-off, the sleep mode switching, and the idle mode switching of the nonvolatile memory apparatus 100.

This allows the host 300 to secure a number of free blocks corresponding to the reference number before any of the power-off, the sleep mode switching, and the idle mode switching of the nonvolatile memory apparatus 100 is performed. When the host 300 secures in advance the corresponding number of free blocks in this way, the speed of data writing corresponding to a data write command generated from the host 300 may be improved. That is, in accordance with the present embodiment, it is possible to prevent a delay for data writing due to a shortage of free blocks.

When switching the nonvolatile memory apparatus 100 to the garbage collection mode as the garbage collection request is received, the data storage device 10 may allocate the open block GC open block for garbage collection for performing the garbage collection operation among the first open blocks for purposes other than garbage collection, and perform the garbage collection operation.

The data storage device 10 may include the nonvolatile memory apparatus 100 and the controller 200.

The nonvolatile memory apparatus 100 may include a plurality of memory blocks allocated as the first open blocks for purposes other than garbage collection.

When switching the nonvolatile memory apparatus 100 to the garbage collection mode, the controller 200 may allocate the open block GC open block for garbage collection for performing the garbage collection operation among the first open blocks, and copy data stored in valid pages of a victim block, and store the copied data into the open block GC open block for garbage collection during the garbage collection operation, thereby securing a free block. The first open block may include an open block for internal operations including wear leveling and read reclaim and an open block Host open block for host write.

The controller 200 may repeatedly perform the garbage collection operation until the total number of free blocks is equal to the reference number.

When selecting victim blocks during the garbage collection operation, the controller 200 may select a number of victim blocks corresponding to a difference between the reference number and the total number of free blocks, in an ascending order of the number of valid pages among a plurality of victim block candidates.

During the garbage collection operation, the controller 200 may check a free space of the open block GC open block for garbage collection and the number of valid pages of the victim block and determine whether the checked free space can store all data stored in the valid pages of the victim block.

When the victim block includes at least one super block, the controller 200 may compare the number of all valid pages of the at least one super block with the free space of the open block GC open block for garbage collection.

When it is not possible to store all the data, which are stored in the valid pages of the victim block, in the free space of the open block GC open block for garbage collection, if the free space of the open block GC open block for garbage collection is being reduced less than a preset reference value while the valid pages of the victim block are being copied to the open block GC open block, the controller 200 may allocate a next open block for garbage collection among the first open blocks.

The aforementioned first open block, victim block, free block, and open block GC open block for garbage collection may each be a super block including at least two blocks (see FIG. 2, FIG. 3, FIG. 5, and FIG. 6) or a single block including one block (see FIG. 4).

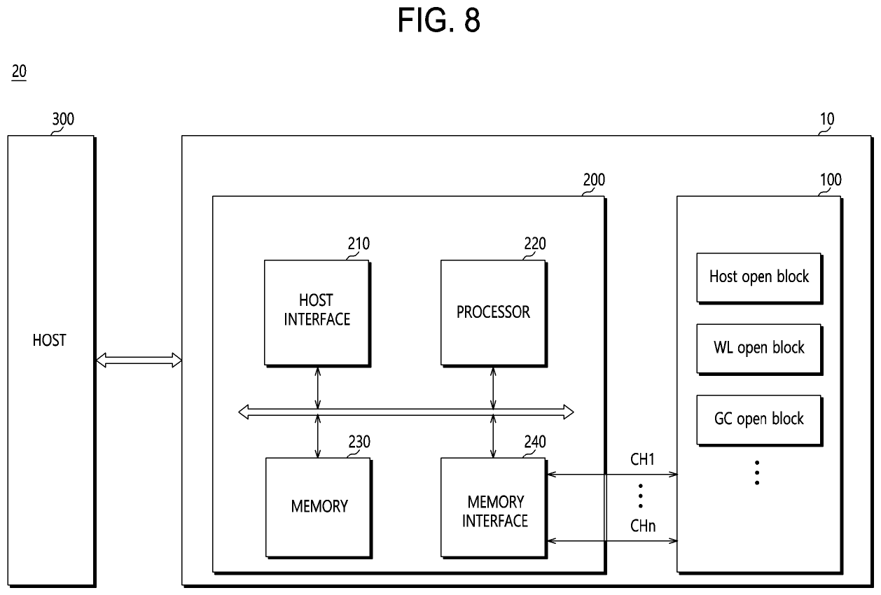

FIG. 9 is a diagram illustrating a data processing system including a solid state drive (SSD) in accordance with an embodiment of the present disclosure. Referring to FIG. 9, a data processing system 2000 may include a host 2100 and a solid state drive (hereinafter, referred to as SSD) 2200.

The SSD 2200 may include a controller 2210, a buffer memory apparatus 2220, nonvolatile memory apparatuses 2231 to 223n, a power supply 2240, a signal connector 2250, and a power connector 2260.

The controller 2210 may control all operations of the SSD 2200.

The buffer memory apparatus 2220 may temporarily store data to be stored in the nonvolatile memory apparatuses 2231 to 223n. Furthermore, the buffer memory apparatus 2220 may temporarily store the data read from the nonvolatile memory apparatuses 2231 to 223n. The data temporarily stored in the buffer memory apparatus 2220 may be transmitted to the host 2100 or the nonvolatile memory apparatuses 2231 to 223n under the control of the controller 2210.

The nonvolatile memory apparatuses 2231 to 223n may be used as a storage medium of the SSD 2200. The nonvolatile memory apparatuses 2231 to 223n may be electrically connected to the controller 2210 through a plurality of channels CH1 to CHn. One or more nonvolatile memory apparatuses may be electrically connected to one channel. The nonvolatile memory apparatuses electrically connected to one channel may be electrically connected to the same signal bus and data bus.

The power supply 2240 may provide power PWR inputted through the power connector 2260 to the inside of the SSD 1200. The power supply 2240 may include an auxiliary power supply 2241. The auxiliary power supply 2241 may supply power such that the SSD 2200 is normally terminated when sudden power off occurs. The auxiliary power supply 2241 may include high-capacity capacitors capable of storing the power PWR.

The controller 2210 may exchange a signal SGL with the host 2100 through the signal connector 2250. The signal SGL may include a command, an address, data and the like. The signal connector 2250 may be composed of various types of connectors according to an interface method between the host 2100 and the SSD 2200.

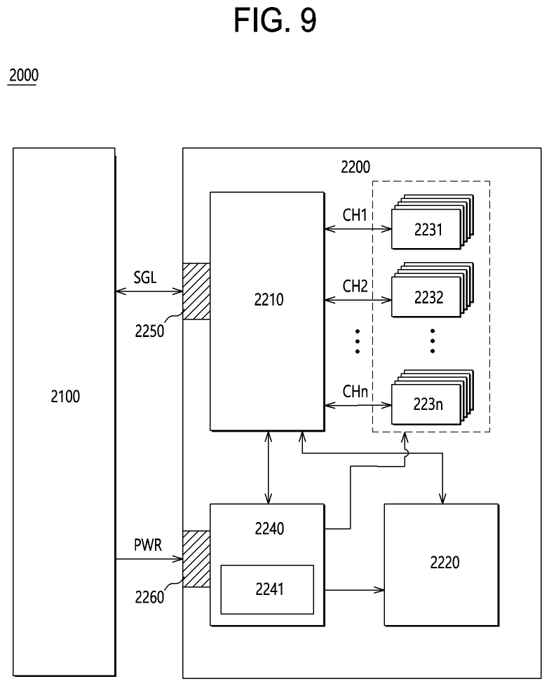

FIG. 10 is a diagram illustrating the controller of FIG. 9 in accordance with an embodiment of the present disclosure. Referring to FIG. 10, the controller 2210 may include a host interface unit 2211, a control unit 2212, a random access memory 2213, an error correction code (ECC) unit 2214, and a memory interface unit 2215.

The host interface unit 2211 may serve as an interface between the host 2100 and the SSD 2200 according to the protocol of the host 2100. For example, the host interface unit 2211 may communicate with the host 2100 through any of protocols such as a secure digital, a universal serial bus (USB), a multi-media card (MMC), an embedded MMC (eMMC), a personal computer memory card international association (PCMCIA), a parallel advanced technology attachment (PATA), a serial advanced technology attachment (SATA), a small computer system interface (SCSI), a serial attached SCSI (SAS), a peripheral component interconnection (PCI), a PCI express (PCI-E), and a universal flash storage (UFS). Furthermore, the host interface unit 2211 may perform a disk emulation function that enables the host 2100 to recognize the SSD 2200 as a general purpose data storage device, for example, as a hard disk drive (HDD).

The control unit 2212 may analyze and process the signal SGL inputted from the host 2100. The control unit 2212 may control the operations of internal function blocks according to firmware or software for driving the SSD 2200. The random access memory 2213 may be used as a working memory for driving such firmware or software.

The error correction code (ECC) unit 2214 may generate parity data of data to be transmitted to the nonvolatile memory apparatuses 2231 to 223n. The generated parity data may be stored in the nonvolatile memory apparatuses 2231 to 223n together with the data. On the basis of the parity data, the error correction code (ECC) unit 2214 may detect an error of the data read from the nonvolatile memory apparatuses 2231 to 223n. When the detected error is within a correctable range, the error correction code (ECC) unit 2214 may correct the detected error.

The memory interface unit 2215 may provide a control signal, such as a command and an address, to the nonvolatile memory apparatuses 2231 to 223n under the control of the control unit 2212. Furthermore, the memory interface unit 2215 may exchange data with the nonvolatile memory apparatuses 2231 to 223n under the control of the control unit 2212. For example, the memory interface unit 2215 may provide the nonvolatile memory apparatuses 2231 to 223n with data stored in the buffer memory apparatus 2220 or provide the buffer memory apparatus 2220 with data read from the nonvolatile memory apparatuses 2231 to 223n.

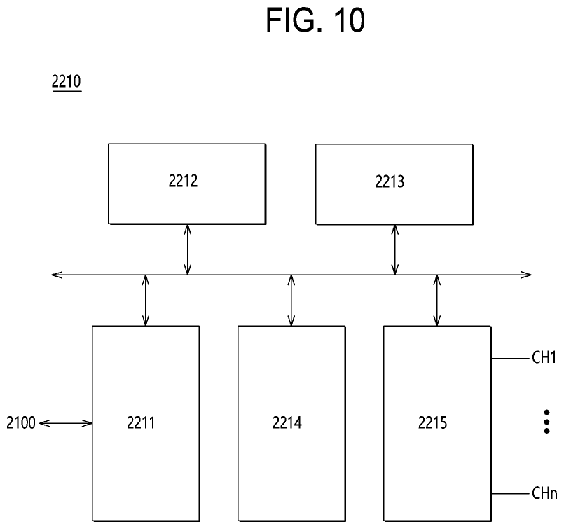

FIG. 11 is a diagram illustrating a data processing system including a data storage device in accordance with an embodiment of the present disclosure. Referring to FIG. 11, a data processing system 3000 may include a host 3100 and a data storage device 3200.

The host 3100 may be configured in the form of a board such as a printed circuit board. Although not illustrated in the drawing, the host 3100 may include internal function blocks for performing the functions of the host.

The host 3100 may include an access terminal 3110 such as a socket, a slot, and a connector. The data storage device 3200 may be mounted to the access terminal 3110.

The data storage device 3200 may be configured in the form of a board such as a printed circuit board. The data storage device 3200 may be called a memory module or a memory card. The data storage device 3200 may include a controller 3210, a buffer memory apparatus 3220, nonvolatile memory apparatuses 3231 and 3232, a power management integrated circuit (PMIC) 3240, and an access terminal 3250.

The controller 3210 may control all operations of the data storage device 3200. The controller 3210 may be configured in the same manner as the controller 2210 illustrated in FIG. 10.

The buffer memory apparatus 3220 may temporarily store data to be stored in the nonvolatile memory apparatuses 3231 and 3232. Furthermore, the buffer memory apparatus 3220 may temporarily store the data read from the nonvolatile memory apparatuses 3231 and 3232. The data temporarily stored in the buffer memory apparatus 3220 may be transmitted to the host 3100 or the nonvolatile memory apparatuses 3231 and 3232 under the control of the controller 3210.

The nonvolatile memory apparatuses 3231 and 3232 may be used as a storage medium of the data storage device 3200.

The PMIC 3240 may provide power inputted through the access terminal 3250 to the inside of the data storage device 3200. The PMIC 3240 may manage the power of the data storage device 3200 under the control of the controller 3210.

The access terminal 3250 may be electrically connected to the access terminal 3110 of the host 3100. A signal such as a command, an address, and data and power may be transferred between the host 3100 and the data storage device 3200 through the access terminal 3250. The access terminal 3250 may be configured in various forms according to an interface method between the host 3100 and the data storage device 3200. The access terminal 3250 may be disposed on one side of the data storage device 3200.

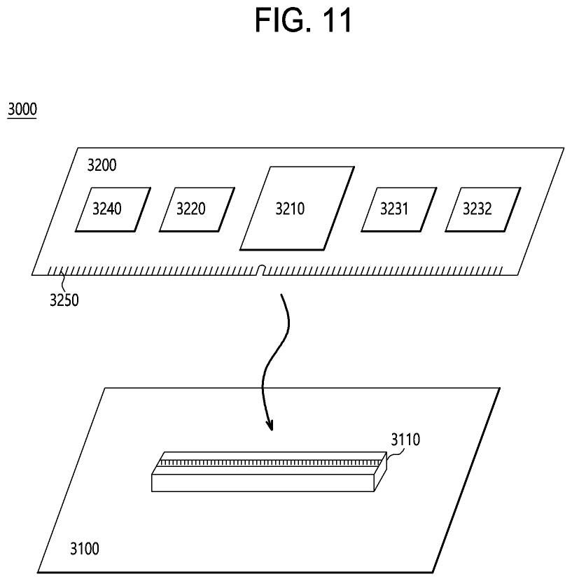

FIG. 12 is a diagram illustrating a data processing system including a data storage device in accordance with an embodiment of the present disclosure. Referring to FIG. 12, a data processing system 4000 may include a host 4100 and a data storage device 4200.

The host 4100 may be configured in the form of a board such as a printed circuit board. Although not illustrated in the drawing, the host 4100 may include internal function blocks for performing the functions of the host.

The data storage device 4200 may be configured in a surface mount package form. The data storage device 4200 may be mounted to the host 4100 through solder balls 4250. The data storage device 4200 may include a controller 4210, a buffer memory apparatus 4220, and a nonvolatile memory apparatus 4230.

The controller 4210 may control all operations of the data storage device 4200. The controller 4210 may be configured in the same manner as the controller 2210 illustrated in FIG. 10.

The buffer memory apparatus 4220 may temporarily store data to be stored in the nonvolatile memory apparatus 4230. Furthermore, the buffer memory apparatus 4220 may temporarily store the data read from the nonvolatile memory apparatus 4230. The data temporarily stored in the buffer memory apparatus 4220 may be transmitted to the host 4100 or the nonvolatile memory apparatus 4230 under the control of the controller 4210.

The nonvolatile memory apparatus 4230 may be used as a storage medium of the data storage device 4200.

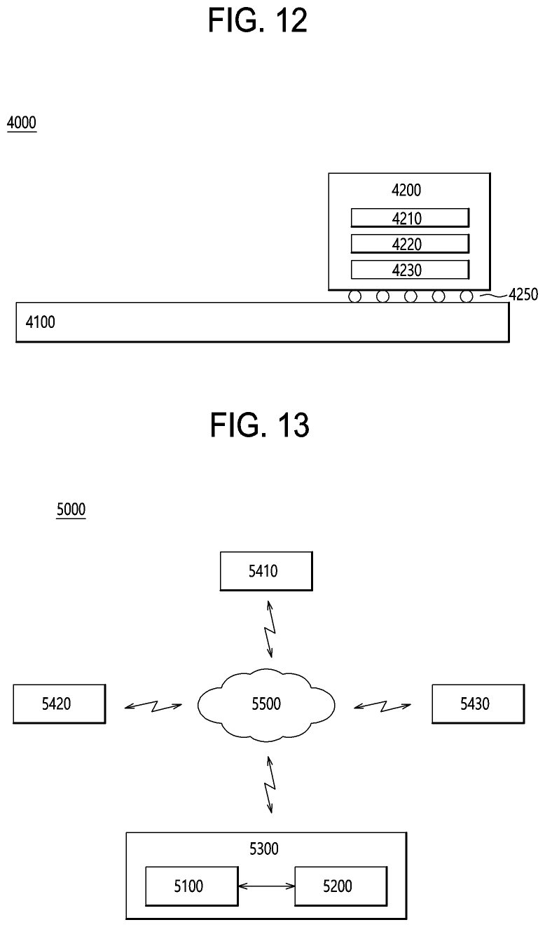

FIG. 13 is a diagram illustrating a network system 5000 including a data storage device in accordance with an embodiment of the present disclosure. Referring to FIG. 13, the network system 5000 may include a server system 5300 and a plurality of client systems 5410, 5420, and 5430, which are electrically connected to one another, through a network 5500.

The server system 5300 may service data in response to requests of the plurality of client systems 5410, 5420, and 5430. For example, the server system 5300 may store data provided from the plurality of client systems 5410, 5420, and 5430. As another example, the server system 5300 may provide data to the plurality of client systems 5410, 5420, and 5430.

The server system 5300 may include a host 5100 and a data storage device 5200. The data storage device 5200 may be configured as the data storage device 10 of FIG. 1, the data storage device 2200 of FIG. 9, the data storage device 3200 of FIG. 11, and the data storage device 4200 of FIG. 12.

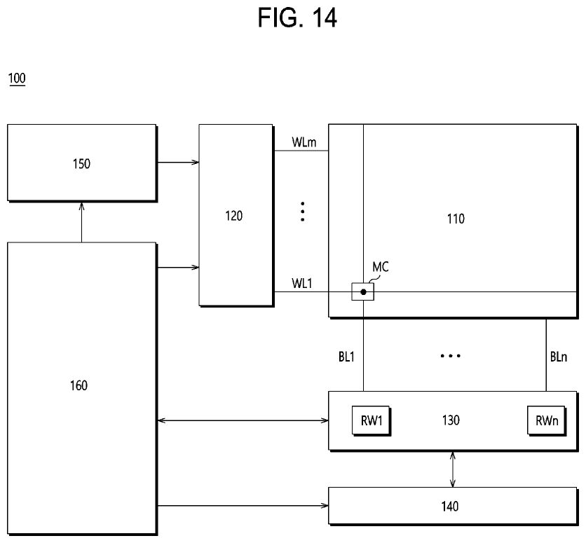

FIG. 14 is a block diagram illustrating a nonvolatile memory apparatus included in a data storage device in accordance with an embodiment of the present disclosure. Referring to FIG. 14, a nonvolatile memory apparatus 100 may include a memory cell array 110, a row decoder 120, a column decoder 140, a data read/write block 130, a voltage generator 150, and a control logic 160.

The memory cell array 110 may include memory cells MC arranged in intersection areas of word lines WL1 to WLm and bit lines BL1 to BLn.

The row decoder 120 may be electrically connected to the memory cell array 110 through the word lines WL1 to WLm. The row decoder 120 may operate under the control of the control logic 160.

The row decoder 120 may decode an address provided from an external device (not illustrated). The row decoder 120 may select and drive the word lines WL1 to WLm on the basis of the decoding result. For example, the row decoder 120 may provide the word lines WL1 to WLm with a word line voltage provided from the voltage generator 150.

The data read/write block 130 may be electrically connected to the memory cell array 110 through the bit lines BL1 to BLn. The data read/write block 130 may include read/write circuits RW1 to RWn corresponding to the bit lines BL1 to BLn, respectively. The data read/write block 130 may operate under the control of the control logic 160. The data read/write block 130 may operate as a write driver or a sense amplifier according to an operation mode. For example, the data read/write block 130 may operate as a write driver that stores data, provided from an external device, in the memory cell array 110 during a write operation. As another example, the data read/write block 130 may operate as a sense amplifier that reads data from the memory cell array 110 during a read operation.

The column decoder 140 may operate under the control of the control logic 160. The column decoder 140 may decode an address provided from an external device. The column decoder 140 may electrically connect the read/write circuits RW1 to RWn of the data read/write block 130, which correspond to the bit lines BL1 to BLn, respectively, to data input/output lines (or data input/output buffers), on the basis of the decoding result.

The voltage generator 150 may generate voltages to be used in the internal operations of the nonvolatile memory apparatus 100. The voltages generated by the voltage generator 150 may be applied to the memory cells of the memory cell array 110. For example, a program voltage generated during a program operation may be applied to word lines of memory cells to be subjected to the program operation. As another example, an erase voltage generated during an erase operation may be applied to well regions of memory cells to be subjected to the erase operation. In another example, a read voltage generated during a read operation may be applied to word lines of memory cells to be subjected to the read operation.

The control logic 160 may control all operations of the nonvolatile memory apparatus 100 on the basis of a control signal provided from an external device. For example, the control logic 160 may control the operations of the nonvolatile memory apparatus 100 such as read, write, and erase operations.

In the aforementioned present embodiments, since the open block Host open block for host write and the open block for internal operations are used, instead of free blocks, in the mode in which only the garbage collection is operated, a write amplification factor (WAF) is reduced due to the use of over-provisioning, so that it is possible to expect an effect of performing an efficient garbage collection operation.

Since a person skilled in the art to which the present disclosure pertains may carry out the present disclosure in other specific forms without changing its technical spirit or essential features, it should be understood that the embodiments described above are illustrative in all respects, not limitative. The scope of the present disclosure is defined by the claims to be described below rather than the detailed description, and it should be construed that the meaning and scope of the claims and all changes or modified forms derived from the equivalent concept thereof are included in the scope of the present disclosure.

What is claimed is:

1. A data storage device comprising:
a nonvolatile memory apparatus including a plurality of memory blocks allocated as first open blocks for purposes other than garbage collection; and
a controller configured to allocate, among the first open blocks, an open block for garbage collection for performing a garbage collection operation when switching the nonvolatile memory apparatus to a garbage collection mode, and to copy data stored in valid pages of a victim block, to store the copied data into the open block for garbage collection, and to erase the victim block during the garbage collection operation, thereby securing a free block.

2. The data storage device according to claim 1, wherein, when a total number of free blocks in the nonvolatile memory apparatus is equal to or less than a reference number or when a garbage collection command transferred from a host is received, the controller is further configured to switch the nonvolatile memory apparatus to the garbage collection mode in which only the garbage collection operation is performed.

3. The data storage device according to claim 2, wherein the controller is further configured to repeatedly perform the garbage collection operation until the total number of free blocks is equal to the reference number.

4. The data storage device according to claim 2, wherein the controller is further configured to select a number of the victim block corresponding to a difference between the reference number and the total number of free blocks, in an ascending order of numbers of valid pages included in memory blocks.

5. The data storage device according to claim 4,
wherein, during the garbage collection operation, the controller is further configured to check a free space of the open block for garbage collection and the number of valid pages of the victim block and determine whether the checked free space is able to store all data stored in the valid pages of the victim block, and
wherein, when the victim block includes at least one super block, the controller is further configured to compare the number of all valid pages of the at least one super block with the free space of the open block for garbage collection.

6. The data storage device according to claim 5, wherein, when it is not possible to store all the data, which are stored in the valid pages of the victim block, in the free space of the open block for garbage collection, the controller is further configured to allocate a next open block for garbage collection among the first open blocks when the free space of the open block for garbage collection is being reduced less than a preset reference value while the valid pages of the victim block are being copied to the open block GC open block.

7. The data storage device according to claim 1, wherein, when switching the nonvolatile memory apparatus to the garbage collection mode, the controller is further configured to increase a total number of free blocks by adding free blocks reserved for host write and internal operations to a free block list.

8. The data storage device according to claim 1, wherein, during the garbage collection operation, the controller is further configured to determine a final write position of the open block for garbage collection by referring to a mapping table and store the data, which are stored in the valid pages of the victim block, into a position following the determined final write position.

9. The data storage device according to claim 1, wherein the first open block includes an open block for internal operations including wear leveling and read reclaim operations and an open block for a host write operation.

10. The data storage device according to claim 1, wherein each of the first open block, the victim block, the free block, and the open block for garbage collection is a super block including one or more blocks.

11. A data processing system comprising:
a host configured to generate a garbage collection request for performing only a garbage collection operation according to a preset condition; and
a data storage device configured to allocate an open block for garbage collection for performing the garbage collection operation among first open blocks for purposes other than garbage collection when switching to a garbage collection mode as a garbage collection request is received, and to perform the garbage collection operation.

12. The data processing system according to claim 11,
wherein the host generates the garbage collection request before one of power-off, sleep mode switching, and idle mode switching of the data storage device is performed or when a total number of free blocks in a nonvolatile memory apparatus included in the data storage device is equal to or less than a reference number, and
wherein the host is further configured to transmit the garbage collection request to the data storage device.

13. The data processing system according to claim 12, wherein the host is further configured to perform one of the power-off, the sleep mode switching, and the idle mode switching of the data storage device when receiving a garbage collection completion response from the data storage device as a response to the garbage collection request provided before one of the power-off, the sleep mode switching, and the idle mode switching of the data storage device is performed.

14. The data processing system according to claim 12, wherein the data storage device comprises:
the nonvolatile memory apparatus including a plurality of memory blocks allocated as the first open blocks for purposes other than garbage collection; and
a controller configured to allocate the open block for garbage collection for performing the garbage collection operation when switching the nonvolatile memory apparatus to the garbage collection mode, and to copy data stored in valid pages of a victim block, to store the copied data into the open block for garbage collection, and to erase the victim block during the garbage collection operation, thereby securing a free block.

15. The data processing system according to claim 14, wherein the controller is further configured to repeatedly perform the garbage collection operation until the total number of free blocks is equal to the reference number.

16. The data processing system according to claim 14, wherein the controller is further configured to select a number of the victim block corresponding to a difference between the reference number and the total number of free blocks, in an ascending order of numbers of valid pages included in memory blocks.

17. The data processing system according to claim 16,
wherein, during the garbage collection operation, the controller is further configured to check a free space of the open block for garbage collection and the number of valid pages of the victim block and determine whether the checked free space is able to store all data stored in the valid pages of the victim block, and
wherein, when the victim block includes at least one super block, the controller is further configured to compare the number of all valid pages of the at least one super block with the free space of the open block for garbage collection.

18. The data processing system according to claim 17, wherein, when it is not possible to store all the data, which are stored in the valid pages of the victim block, in the free space of the open block for garbage collection, the controller is further configured to allocate a next open block for garbage collection among the first open blocks when the free space of the open block for garbage collection is being reduced less than a preset reference value while the valid pages of the victim block are being copied to the open block GC open block.

19. The data processing system according to claim 11, wherein the first open block includes an open block for internal operations including wear leveling and read reclaim operations and an open block for a host write operation.

20. The data processing system according to claim 14, wherein each of the first open block, the victim block, the free block, and the open block for garbage collection is a super block including one or more blocks.

21. A data storage device comprising:
a nonvolatile memory apparatus including open blocks; and
a controller configured to control the nonvolatile memory apparatus to perform, with the open blocks, any of a garbage collection operation, a wear leveling operation, a read reclaim operation and a host write operation,
wherein the nonvolatile memory apparatus performs the garbage collection operation while not performing any of the wear leveling operation, the read reclaim operation and the host write operation.
